(19) United States
(12) Patent Application Publication
(10) Pub. No.: US 2013/0110767 A1
(43) Pub. Date: May 2, 2013

(54) Online Transaction Processing

(71) Applicant: NEC LABORATORIES AMERICA, INC., Princeton, NJ (US)

(72) Inventors: Junichi Tatemura, Cupertino, CA (US); Vahit Hakan Hacigumus, San Jose, CA (US)

(73) Assignee: NEC LABORATORIES AMERICA, INC., Princeton, NJ (US)

(21) Appl. No.: 13/655,663

(22) Filed: Oct. 19, 2012

Related U.S. Application Data
(60) Provisional application No. 61/551,502, filed on Oct. 26, 2011.

(51) Int. Cl. G06F 17/30

(52) U.S. Cl. 707/607; 707/E17.001

(57) ABSTRACT

A method implemented in an online transaction processing system is disclosed. The method includes, upon a read request from a transaction process, reading a transaction log, reading data stored in a storage without accessing the transaction log, and constituting a current snapshot using the data in the storage and the transaction log. The method also includes, upon a write request from the transaction process, committing transaction by accessing the transaction log. The method also includes propagating update in the commit to the data in the storage asynchronously. The transaction commit is made successful upon applying the commit to the transaction log. Other methods and systems also are disclosed.

This application claims the benefit of U.S. Provisional Application No. 61/551,502, entitled, “Elastic Transaction Service Based on Transaction Log Management,” filed Oct. 26, 2011, the contents of which are incorporated herein by reference.

### BACKGROUND OF THE INVENTION

The present invention relates to online transaction processing (OLTP) and, more particularly, to elasticity of OLTP.

To achieve elasticity of OLTP workloads, it would be beneficial to solve the following issues:

Flexibility on consistency guarantee: A traditional relational database management system (RDBMS) provides the full atomicity, consistency, isolation, and durability (ACID) properties on the entire data set. Whereas this global ACID is very powerful, it makes hard for a system to scale, and it is often overkill for most OLTP applications. For instance, typical Web applications serve a large number of users but needs ACID properties in a limited manner.

Elasticity for different scaling factors: The system may adapt to changing workloads by scaling out and in (e.g., adding and removing server resources). OLTP workloads have three factors of scaling: (1) the data size, (2) the number of queries per second, and (3) the number of transactions per second. Although they are closely related, different workloads show different growth patterns on these factors. Since not all the queries are executed in a transactional manner, growth of query throughput does not necessarily mean growth of transaction throughput. It is desirable to have elasticity on one or more of these three factors to adapt to the behavior of various workloads.

A key-value store is a state-of-the-art approach to tackle the above issues. The data is divided into a set of key-value objects and distributed by the key over a cluster of servers. Various key-value stores provide various consistency guarantees for reading and writing a single key-value object. Some systems guarantee the ACID properties on a single key (e.g., they support transaction on a single key-value object). Such key-value stores achieve flexibility on consistency guarantee and some degree of elasticity. However, there is a limitation that transaction and data are tightly coupled. Data and transaction are associated with the same key and distributed together so that a transaction happens locally, avoiding expensive distributed transaction protocols.

Tiered Architecture

Typically transaction is managed between query execution and storage to control all the read/write operations from transactional processes, resulting in the following tiered architecture.

There is related art to decouple transaction elasticity and data elasticity within this architecture. For instance, Deuteronomy [1] decouples data management in the cloud into transaction components and data components. However, the tiered architecture assumes that all the read/write requests go through the transaction manager. Our approach provides a component called a transaction log and, as a result, achieves flexibility for a query execution engine to utilize the transaction component.

Another typical architecture is to have master and slave replica and let the query execution engine choose based on consistency requirement.

Asynchronous replication of traditional RDBMSs is used to support elasticity in a limited fashion: The system can add a new slave node dynamically (i.e. scale out). However, slave may be used for read-only transaction and there is no elasticity for read-write transaction.

PNUTS [3] is a key-value store that takes a master-slave approach. The master data is distributed as key-value objects, and they are replicated asynchronously. The client can choose replica depending on required consistency. However, transaction (on master key-value object) is tightly coupled with the data.

We propose at least one of (1) a transaction protocol that uses a transaction log and (2) a transaction log manager that distributes transaction logs by their keys. See FIG. 4 (B).

[1] Justin J. Levandoski, David B. Lomet, Mohamed F. Mokbel, Kevin Zhao, Deuteronomy: Transaction Support for Cloud Data, CIDR 2011, Fifth Biennial Conference on Innovative Data Systems Research, Asilomar, Calif., USA, Jan. 9-12, 2011

[2] Sudipto Das, Divyakant Agrawal, Amr El Abbadi, ElasTraS: An Elastic Transactional Data Store in the Cloud, USENIX HotCloud 2009.

[3] B. F. Cooper et al. PNUTS: Yahoo!'s hosted Data Serving Platform. PVLDB, 1(2):1277-1288, August 2008.

### BRIEF SUMMARY OF THE INVENTION

An objective of the present invention is to achieve elasticity in online transaction processing (OLTP).

An aspect of the present invention includes a method implemented in an online transaction processing system. The method includes, upon a read request from a transaction process, reading a transaction log, reading data stored in a storage without accessing the transaction log, and constituting a current snapshot using the data in the storage and the transaction log. The method also includes, upon a write request from the transaction process, committing transaction by accessing the transaction log. The method also includes propagating update in the commit to the data in the storage asynchronously. The transaction commit is made successful upon applying the commit to the transaction log.

Another aspect of the present invention includes a system for online transaction processing. The system includes a transaction log; and a storage that stores data. Upon a read request from a transaction process, the system reads a transaction log, reads data stored in a storage without accessing the transaction log, and constitutes a current snapshot using the data in the storage and the transaction log. Upon a write request from the transaction process, the system commits transaction by accessing the transaction log. The system propagates update in the commit to the data in the storage asynchronously. The transaction commit is made successful upon applying the commit to the transaction log.

Another aspect of the present invention includes a method implemented in a transaction log manager used in an online transaction processing system. The method includes, upon a read request from a transaction process, reading a transaction log. The method also includes, upon a write request from the transaction process, committing transaction by accessing the transaction log. The method also includes propagating update in the commit to the data in the storage asynchronously. The online transaction processing system reads data stored in a storage without accessing the transaction log, and constitutes a current snapshot using the data in the storage and the transaction log. The transaction commit is made successful upon applying the commit to the transaction log.

### BRIEF DESCRIPTION OF THE DRAWINGS

FIG. 1 depicts an elastic transaction management system.

FIG. 2 depicts a proposed approach to transaction.

FIG. 3 depicts a related approach with master-slave replication.

FIG. 4 depicts system components.

FIG. 5 depicts a cluster of transaction log manager.

FIG. 6 depicts a SYNC time.

FIG. 7 depicts a SNAPSHOT time.

FIG. 8 depicts check predicate in a commit.

FIG. 9 depicts interaction to synchronize a partition.

FIG. 10 depicts log retrieval.

FIG. 11 depicts independence of partition mappings.

FIG. 12 depicts message processing architecture.

FIG. 13 depicts an outgoing message buffer.

FIG. 14 depicts incoming message buffers.

FIG. 15 depicts guaranteed message delivery.

FIG. 16 depicts an example of a B-link tree index and conflicting writes.

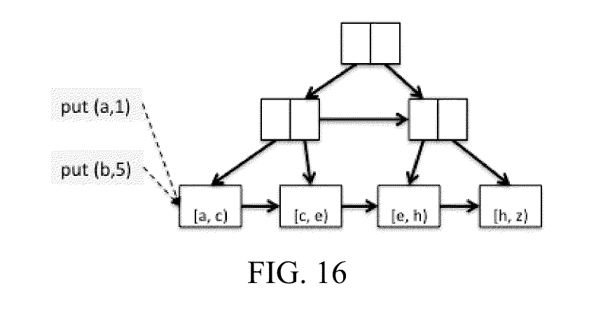

FIG. 17 depicts a single transaction log for each tree.

FIG. 18 depicts splitting transaction logs when splitting nodes.

FIG. 19 depicts a sequence of node split.

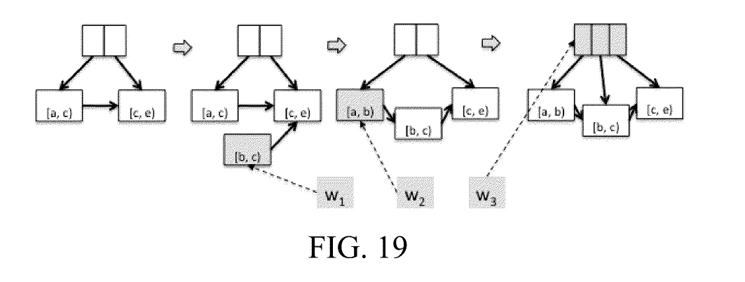

FIG. 20 depicts transient inconsistency due to out-of-order writes.

FIG. 21 depicts anomaly due to repeated writes.

FIG. 22 depicts a data structure of transaction log.

### DETAILED DESCRIPTION

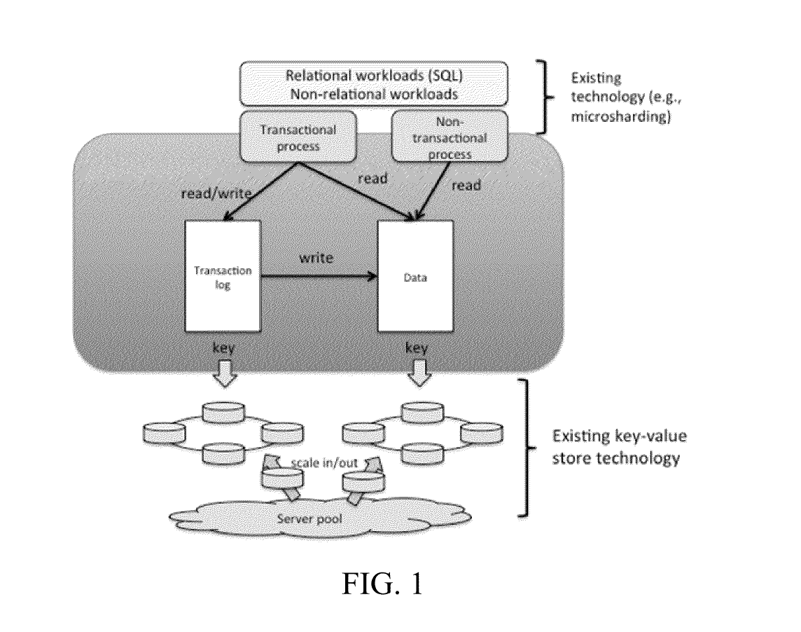

We disclose a novel way to manage transactions over data that makes use of transaction logs. See FIG. 1.

The system manages concurrent transactions to generate a set of operation sequences, which are called transaction logs. Each transaction log is applied to update a disjoint set of data in the storage. Since it is written and made durable before the storage is updated, a transaction log can be seen as a WAL (write-ahead log). However, the key difference from the traditional WAL is that a transaction commit is made successful when it is applied to the transaction log before the storage is updated with the log. When the transaction is committed, a client (a query execution engine) may not see the up-to-date values in the storage. To see the “current” snapshot of the data, the client needs to see the state of a transaction log as well as the data in the storage.

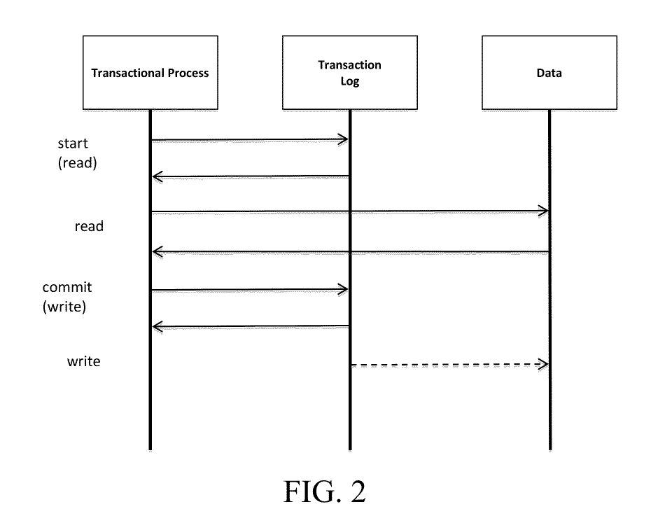

A difference is use of a transaction log to achieve transactions. A flow (protocol) of transaction processing is illustrated in FIG. 2.

(1) The transaction process can directly access the data without a transaction log, and (2) the transaction process can commit transaction without the data store involved. The update in the commit will be propagated to the data asynchronously.

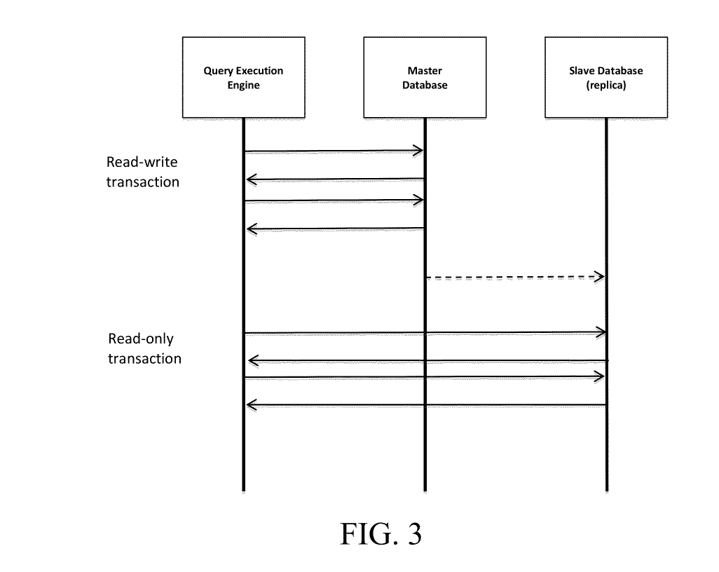

In some sense, we may see the transaction log is the master of the database and the storage is an asynchronous replica. This interpretation is conceptually right. However, the actual system architecture is different from this master-slave relationship: The transaction log is responsible for durability for the updates that are not applied to the storage. This distinction between a transaction log and master data is important since we can implement a transaction log in a more lightweight manner without the responsibility of the master data durability. In many applications, the size of transaction logs that may be preserved is much smaller than the size of the data set. The size of the transaction log data can be kept small, for example, by discarding transaction log data that has been propagated to the storage. Notice that scaling out/in (including data migration) becomes more efficient when data associated with key is small. See FIGS. 2 and 3.

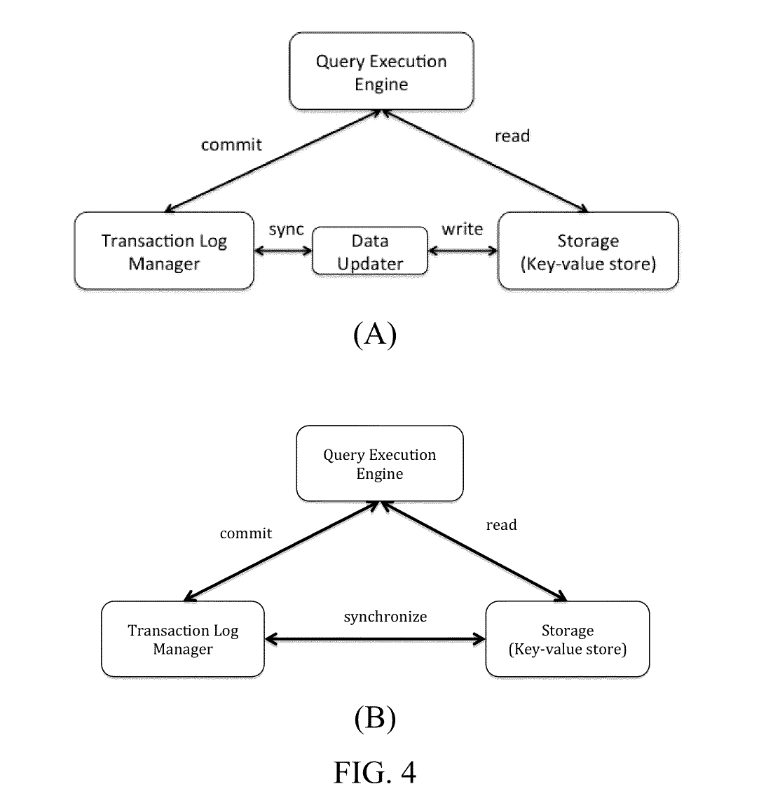

The system manages a large number of transaction logs that are distributed over a cluster of nodes, just like a data set is distributed over a key-value store. See FIG. 4(A).

The query execution engine runs an application's queries by accessing the storage and the transaction log manager. During the execution, it reads data (e.g., table records, indices, or disk pages) mostly from the storage. When the query execution engine runs a transaction, it accesses to the transaction log manager (e.g., starting and committing transactions). When committing, it gives all the write operations in a transaction to the transaction log manager. These write operations are asynchronously applied to the storage by the data updater.

One type of query execution engines is a SQL engine for relational workload. We have proposed a technique called microsharding that provides a declarative approach to achieve elasticity for OLTP workloads. In this model, a microshard is a logical data partition with which the database can provide ACID property. By using a transaction log for each microshard, we can implement microsharding efficiently on the system we propose in this document.

Moreover, this architecture is applicable to non-relational query execution engine. The transaction manager is general enough to be used to introduce transactions to non-relational workloads on key-value stores.

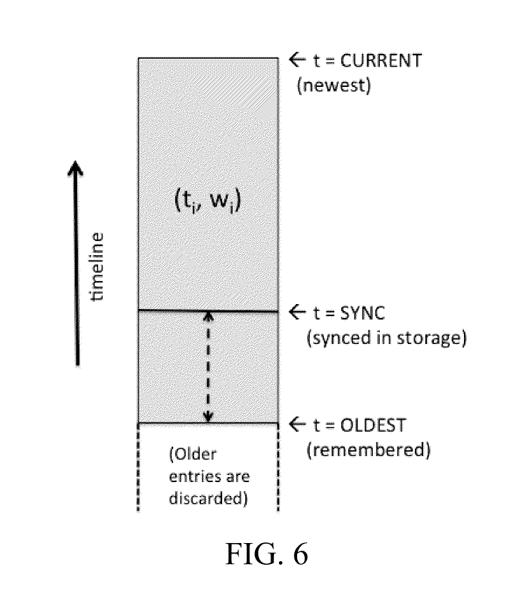

A transaction log is visualized in FIGS. 6, 7, and 8. This transaction log enables the following two steps (transaction start and commit):

Snapshot start(LogId id); and

boolean commit(LogId id, Check check, Write[ ] writes).

1. Implementation

(1) Transaction Log Manager

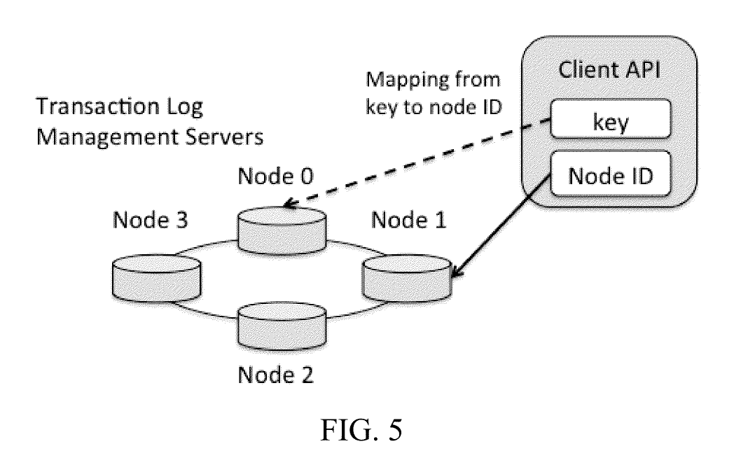

The transaction log manager comprises of a cluster of servers, which handle transaction logs in a distribute manner. The cluster employs a technique of key-value stores that maintains mapping from the key of a transaction log to the ID of the corresponding cluster node. See FIG. 5.

Specifically, we employ the same mapping scheme as Dynamo (or its open-source implementation Voldemort). The key is mapped by a specific hash function to one-dimensional space, which is divided into small partitions. Mapping from partitions to cluster nodes is maintained in an elastic manner: a partition may move from one node to another.

Unlike Dynamo, we allow a single master partition. All the transactional operations may be processed at a node that has the master partition.

There have been proposed techniques to maintain consistent replication efficiently by extending Paxos protocol. For instance we can use such techniques to achieve online rebalancing of partitions among nodes.

(2) Extended Architecture to Support Messaging

In order to implement asynchronous update outside of a single transaction, we may need a mechanism of messaging. For instance, in the microsharding model, if we want to maintain an index on non-transactional key, it may be maintained through messaging because updates on this index and the corresponding table cannot be done in a single transaction.

In this patent application, we first discuss the system without messaging for simplicity. We then describe extension of the system to support messaging.

2. Client API (Application Programming Interface) Overview

The following is an interface of the client API provided by the transaction log manager. In this section, we describe high-level ideas behind this interface. We will discuss details in later sections. We will also extend this interface to support asynchronous messaging later.

interface TransactionLogManager {
// Transaction start and commit

Snapshot start(LogId id);
long startTime(LogId id);
boolean commit(LogId id, Check check, Write[ ] writes);
// Storage syncrhonization
void sync(LogId id, long timestamp);
Node[ ] getNodes( );
Iterable<Entry<LogId, LogEntry[ ]>> getLog(int partitionId);

}

(1) API for Query Execution Engines

The transaction manager provides a query execution engine with operations to start and commit a transaction.

In fact, starting a transaction is just to retrieve the current state of the transaction log and does not change the state (e.g., the transaction log manager does not remember the start of a transaction).

A commit operation is, for example, an atomic check-and-put operation that enables optimistic concurrency control.

Both start and commit are non-blocking operations, meaning that no other process (e.g. another query execution engine) blocks the operation.

(2) API for Data Updaters

The updater may continuously retrieve the log data (write operations) and apply them to the storage. It can also let the transaction log manager know that those operations have been applied so that the transaction logs can be truncated whenever appropriate.

The updater can perform this task asynchronously with respect to query execution engines. If the size of transaction logs is unbounded, the updater will never block the query execution engine. If the log size is bounded and a transaction log becomes full, a transaction commit will be failed (instead of being blocked). The updater's operations are also non-blocking Reading an empty transaction log immediately returns an empty result without waiting for incoming write operations.

3. Data Types

This section describes the data structures the transaction log manager uses.

(1) Key Value Data Collections

Data is represented as a set of data collections. A data collection is a set of key-value objects and has a unique name. A data collection might represent a table of a database or an index—although the transaction manager does not have to be aware of that.

The key is unique within an individual collection. Thus, to identify a key value object, we may need to specify a pair of name and key. A key is serialized as a byte array when it is given to the transaction manager.

A value is also given as a byte array. The transaction manager does not have to interpret the content of the value.

(2) Transaction Log

A transaction log is identified with a pair of name and key.

The name identifies a collection of transaction logs that are managed in the same policy (the query execution engine Particle uses this as a transaction class name). The type of the name is String. In the future, the transaction log manager may provide management operations using this name to access a specific set of transaction logs (e.g., enabling and disabling commits selectively).

The key is an identifier of a transaction log that is unique within the named collection of transaction log. Thus, to identify a transaction log, we may need to specify a pair of name and key. The type of the key is a byte array. The query engine encodes various data types into this byte array, but the transaction manager does not have to be aware of that.

interface LogId {

String getName( );
byte[ ] getKey( );

}

Mapping from this log ID to partition ID is done by an internal logic of the transaction log manager. We may consider an additional API to inquire the partition ID for a given log ID, although this is not necessary to implement the functionalities covered in this document.

Timestamp

A timestamp is a value that gives a total order of commits. The timestamp is defined and maintained for each transaction log, and incremented for each commit. Comparing timestamps between different transaction logs does not mean anything.

In the current design, a timestamp is represented as a long integer. If the value reaches the maximum number, the transaction manager may need to restart the transaction log: make this transaction log offline and reset the timestamp. To make a transaction log offline, first disable new commits (except read-only commits) and wait for the updater synchronizes the all the write operations in the log.

Log Entries

A transaction log maintains a sequence of write operations associated with timestamp, which we refer to as a log entry. For each commit of a write transaction, new log entries are appended to the sequence. The updater scans this sequence of log entries and applies the write operations to the storage.

interface LogEntry {

long getTimestamp( );
Write getWrite( );

}

A log entry is a write operation associated with a timestamp. A timestamp is a logical value that is maintained for each transaction log.

interface Write {

byte[ ] getName( );
byte[ ] getKey( );
byte[ ] getValue( );

}

A write operation consists of three items: (1) the name of the data collection, (2) the key of the data object, and (3) the value of the data object.

We assume the state of a key-value object is determined by the last write operation. This is true for a write operation that overwrites the entire value of the key-value object.

SYNC Time

A transaction log maintains the timestamp, referred to as SYNC, which means that the storage has incorporated all the write operations whose timestamp are equal to or older than SYNC.

The transaction log manager is responsible of durability of write operations after SYNC. Although it can discard log entries older than SYNC, it may remember older entries for some duration: as we will see in the section on check predicates, remembering older entries reduces the possibility of false positive of conflict detection, which does not affects correctness but worsens performance. See FIG. 6.

Snapshot

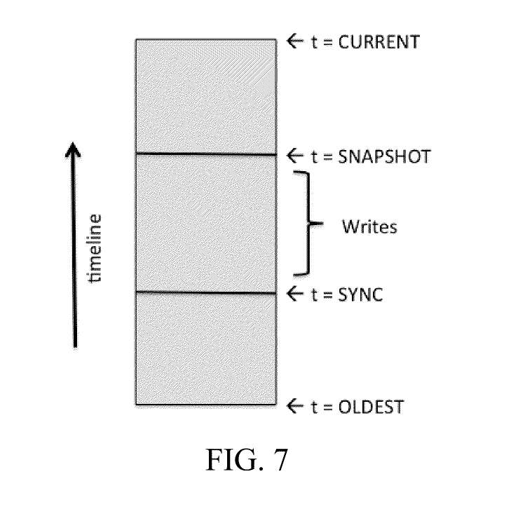

A snapshot is a sequence of writes starting from the time next to SYNC and ending at a particular time. We define this ending time as the timestamp of a snapshot. This snapshot time can be anytime between SYNC and CURRENT (SNAPSHOT ε [SYNC, CURRENT]). When a sequence of writes is empty (e.g., when SYNC=CURRENT), the snapshot time is equal to SYNC. See FIG. 7.

interface Snapshot {

long getTimestamp( );
Write[ ] getWrites( );

}

When a transaction starts on a transaction log, a query execution engine can retrieve a snapshot to know recent write operations.
Snapshot start(LogId id);

The transaction log manager can use the CURRENT time at that moment to give all the write operations between (SYNC, CURRENT]. However, notice that this operation does not block other transaction processes to commit new write operations, and the snapshot time may no longer CURRENT by the time the query execution engine receives the result.

In fact, the transaction log manager can use any time between SYNC and CURRENT as the snapshot time. It can even return SYNC and an empty write sequence. It can limit the size of a snapshot to return. The choice is left for the transaction log manager as a performance tuning parameter.

Optional Duplicate Elimination:

When there are multiple operations on the same key-value object, the transaction log manager can eliminate older operations and preserve the most recent one. Notice that this duplicate elimination is optional. The query execution engine can interpret the snapshot as a sequence (in the chronological order) that may contain multiple operations on the same key-value object. Whether the transaction log manager can eliminate duplication is a matter of performance tuning (CPU time vs. message size).

Check Predicates

A check is successful if there is no conflicting log entry. A log entry conflicts with the committing transaction if it writes a key-value object after the transaction reads it.

A check is represented as a timestamp and a set of read sets. The value of the timestamp is given when the transaction is started (SYNC time or snapshot time).

interface Check {

long getTimestamp( );
Read[ ] getReadSets( );

}

A read set consists of a set of keys in the same collection.

interface ReadSet {

byte[ ] getName( );
byte[ ][ ] getKeys( );

}

Given a check the transaction manager checks if there is any write operations between (Tc, CURRENT] that conflict with the read set where Tc is the timestamp of the check.

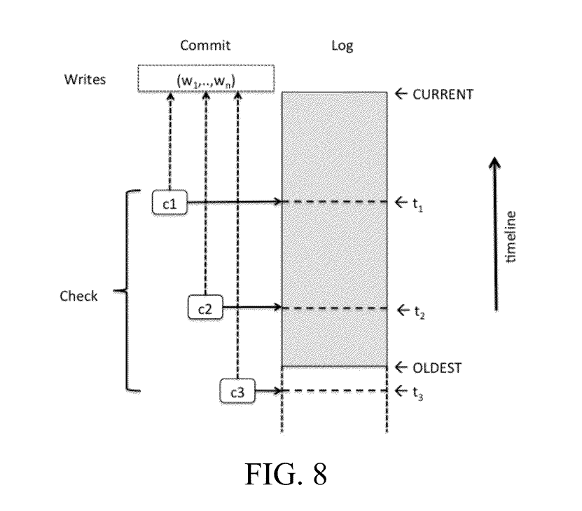

If Tc is older than OLDEST, the transaction manager cannot make sure there is no conflict. The result of check is false in this case. See FIG. 8.

Impact of Restarting:

when a transaction is restarted, the transaction log manager may observe a check which is newer than CURRENT. This may happen if a transaction is running during the restart. In this case, this timestamp may be considered older than OLDEST. The result of the commit is false, accordingly.

(3) Node Information

The transaction log manager provides the current information of the mapping between partitions and cluster nodes. Node is a container of information on each cluster node, including node ID, the URL of the node, and a set of partition IDs that are assigned to this node.

interface Node {

int getId( );
String getUrl( );
int[ ] getPartitionIds( );

}

4. Transaction Management

In this section, we describe the interfaces of the transaction log manager for the query execution manager to execute a transaction.

(1) Start Transaction

When a query execution engine starts a transaction, it can acquire the SYNC time by the following operation:

long startTime(LogId id);

The storage guaranteed that writes before the SYNC time have been applied to the data and the new values are available to its client (the query execution engine). Thus, for key value objects that are read AFTER this transaction start, we can guarantee that their values are not older than SYNC. So, let us call this timestamp T_{c}, which is used for a check in the commit request.

Alternatively, a query execution engine can start a transaction by the following operation:

Snapshot start(LogId id);

As a result, it acquires a timestamp (let us refer to this as Tₛ) and a sequence of write operations that are between SYNC and Tₛ. By applying these operations on the data that is retrieved from the storage (after the transaction start), we can guarantee that their values are not older than Tₛ. In this case, we use this timestamp as T_{c}.

Recall that we assume the state of a key-value object is determined by the last write operation. The snapshot may include operations that are already applied to the data by the data updater. But applying the same operation again to the updated data is safe because of this assumption.

(2) Commit Request

During the transaction execution, the query execution engine can buffer all the write operations and remember all the read sets that potentially conflict with other transactions. The query execution engine can decide to relax transaction isolation (from serializable) to allow non-isolated reads (e.g. read committed) by excluding some of the read operations from the read sets. This freedom comes with responsibility: it is the query execution engine's responsibility to prepare an appropriate check (timestamp and read sets) for desired isolation.

When it requests a commit, it prepares a check using the remembered read sets and timestamp Ts. When a commit request returns true, the transaction is successfully committed. Otherwise, the transaction is rejected. The query execution engine can either start over or abort the transaction.

boolean commit(LogId id, Check check, Write[ ] writes);

5. Storage Synchronization

In this section, we describe how the updater can use the transaction log manager's interface to synchronize the storage with the committed write operations in transaction logs.

(1) Log Retrieval

Log retrieval is done for each partition of transaction logs. To acquire the set of partition IDs, the updater can use the API of the transaction log manager that provides partitioning information:

Node[ ] getNodes( );

For each Node object, we can get a set of partition IDs that are currently assigned to the node:

int[ ] partitionIDs=node.getPartitionlds( );

The mapping between partitions and nodes is not required to operate storage synchronization correctly and can be used for performance tuning. What we want is the entire set of partition IDs.

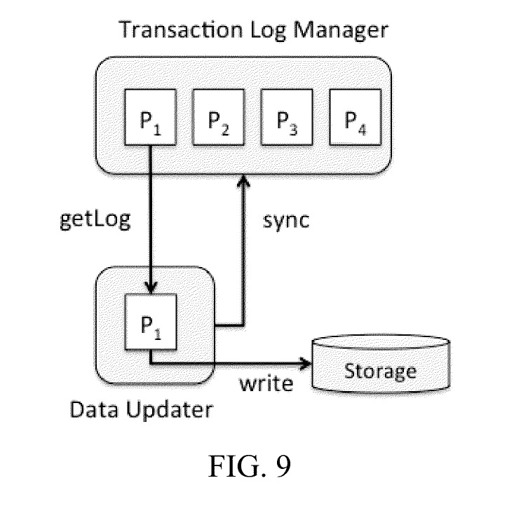

For each partition ID, the update can scan a set of logs in a partition. See FIG. 9.

Iterable<Entry<LogId, LogEntry[ ]>>getLog(int partitionId);

(2) Requirements of getLog Operation

The log information is a sequence of log entries after SYNC. It may be similar to the snapshot. They differ in the sense that each log entry is associated with a timestamp whereas a snapshot has one timestamp for all the write operations.

The transaction manager can choose the ending time between SYNC and CURRENT.

When a transaction log has no write operations after SYNC, the transaction log manager excludes this log from the result (instead of sending an empty sequence).

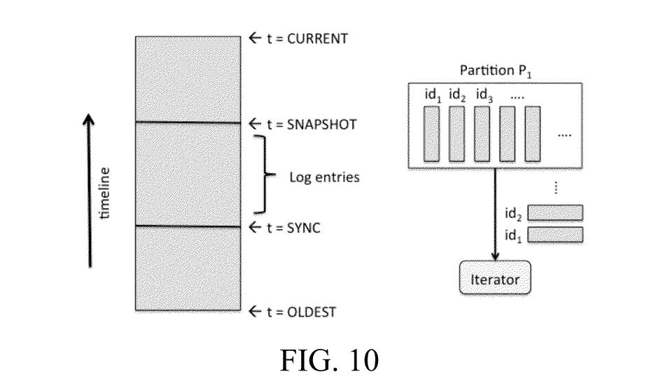

The API provides an iterator over the set of logs. Here, the transaction log manager does not have to scan all the logs in the partition. The transaction log can always stop scanning and let the iteration end (e.g., hasNext be false). For instance, the transaction log manager may want to limit the number (or duration) of iterations for a performance reason. See FIG. 10.

No Duplicate Elimination:

Another important difference from a snapshot is that the transaction log manager may not eliminate duplicate writes (multiple write operations on the same key-value object). All the operations can be preserved in the log with their own timestamp so that the updater (or any other possible user of the log) can replay the operation sequence and produce the state at any timestamp in the log.

(3) Log Synchronization

After the updater performs the write operations and ensure the new values are available for readers (e.g., query execution engines), it gives timestamp Ts to the transaction log manager that all writes whose timestamps are equal to or older than Ts have been processed.

void sync(LogId id, long timestamp);

Notice that, unlike a usual “sync” operation (e.g., of operating systems) that is applied to the storage to perform sync, this sync operation is initiated by the storage-side (the updater) to notify the “sync” has been done.

This operation lets the transaction log manager know that the storage has synced up to the given timestamp (e.g., the new SYNC). From then on, the transaction log no longer has durability responsibility on the data and operations older than this timestamp.

(4) Implementation Issues of Updater

Storage Consistency Requirement:

When we use eventually consistent key-value stores such as Voldemort or Cassandra, the required condition is W+R>N where N is the total number of replica for each key, W is the number of replica to write, and R is the number of replica to read.

When the updater writes W replica successfully, the storage guarantees the client can read (from R replica) the latest value the updater has written. When the write fails, the client may read either new or old value in a nondeterministic manner. This is a safe behavior: since the new value the updater is trying to write is based on the write in the log after SYNC. A commit request will fail for the transaction that uses the value in the nondeterministic state because a check predicate with this read is associated with the timestamp that is older than or equals to SYNC.

Once the updater successfully writes the value, it can update SYNC of the transaction log.

Concurrent Update:

The value of the same key can be written sequentially. When multiple write requests are issued on the same key concurrently, the storage can no longer guarantee the correctness of the transaction.

On the other hand, the updater can write values of different keys concurrently. A (successful) transaction can access these values in an isolated manner. In a later section, we will discuss a case when we want to write values of different keys sequentially in order to provide better consistency for non-transactional (non-isolated) query execution.

Recovery:

Given the assumption that the value of a key-value object is decided by the last write operation, recovery is straightforward. When the updater goes down during the update and restarts, it can restart updating from the current SYNC of the transaction log. Repeating writes that are already applied is safe in terms of isolation guarantee of a transaction: since they are operations after SYNC, a transaction that reads these values will fail.

For a non-isolated read (e.g., reading data without check at commit time), it reads one of the values that are committed. Thus, non-isolated read is “read-committed” (e.g., no dirty read). In a later section, we will discuss a case when we want to have further consistency guarantee for non-isolated reads (as indicated above regarding concurrent update). To do that, we will introduce a way to control the timing of synchronization between the updater and the transaction log manager.

Elastic Mapping of Partitions to Updaters:

We can ensure that one updater process a single partition to avoid concurrent update on the same key. Changing the ownership (a right to process synchronization) of a partition may be handled in the same manner as the transaction log manager in order to enable failover and scale in/out of multiple updaters.

When we assign a partition to an updater, we can make use of the current mapping of the partitions to transaction log manager nodes:

Node[ ] getNodes( );

We may decide mapping of updaters in order to reduce the communication cost. For instance we can consider a setting where one updater is running on each physical server that runs a transaction log manager node and use the same mapping between the transaction log manager and the updaters to make all the communication local.

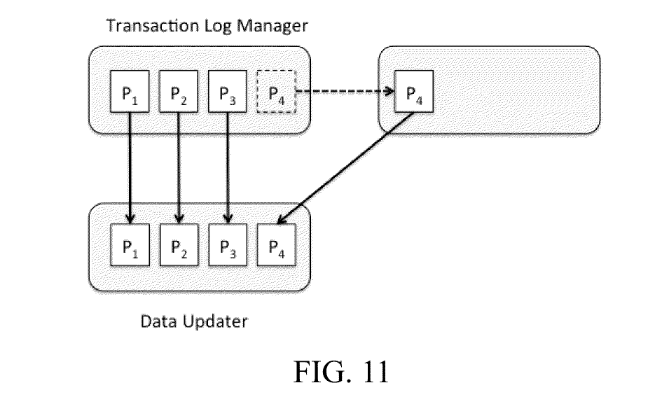

Recall that, however, a partition may move from one node to another in the transaction log manager. See FIG. 11.

The system still works correctly even if the updater is not aware of migration of a partition at the transaction log manager side since any operation (including the sync operation) on a transaction log is processed at the master partition at any time.

However, for a performance reason, the updater may also move the ownership of the partition from one updater node to another. The updater may periodically check the mapping information of the transaction log manager and refine its own mapping of the partition ownership.

In general, the mapping of the partition ownership is independent of the mapping of the transaction log manager. The number of the updater nodes can also be chosen independently.

6. Extension: Messaging

This section extends the transaction log manager to support asynchronous messaging within transactions.

(1) Transaction with Messages

The query execution processor packages sequences of operations on different transaction logs as messages and requests transaction commit together with the messages.

Message

A message contains a sequence of operations and sent to a transaction log that is specified as the destination of the message. A message has a message type that is used to identify a message processor to dispatch the operations.

interface Message {

LogId getDestination( );
String getType( );
Operation[ ] getOperations( );

}

The transaction log manager does not interpret the content of operations and handles them as byte arrays:

interface Operation {

byte[ ] toByte( );

}

At the destination, the transaction log manager identifies the message processor by the message type (message.getType( )). The message processor can de-serialize these byte arrays and interpret as appropriate operations.

Committing with Messages

A commit request operation is extended with an additional argument: a sequence of messages. These messages are queued in an atomic manner if the commit is successful.

boolean commit(LogId id, Check check,
Write[ ] writes, Message[ ] messages);

The query execution manager may pack operations of the same type and the same destination into one message in order to let them processed in an atomic and isolated manner.

(2) Required Guarantees

Whereas the main transaction log processing that manages write operations, we handle general operations in the messaging. The assumption on repeated write operations is no longer valid for the general operation, and duplicating operations may cause incorrect results.

A message can be delivered exactly once, and the order of messages from one transaction log to another may be preserved.

A sequence of operations can be processed within a single transaction at the destination to guarantee atomicity and isolation. However, multiple operation sequences at the same destination can be combined and processed together in one transaction: it is a performance tuning decision of the message processor to combine transactions. The message processor may re-schedule the combined set of operations as long as the correctness is preserved based on the operation semantics.

(3) Extended Architecture

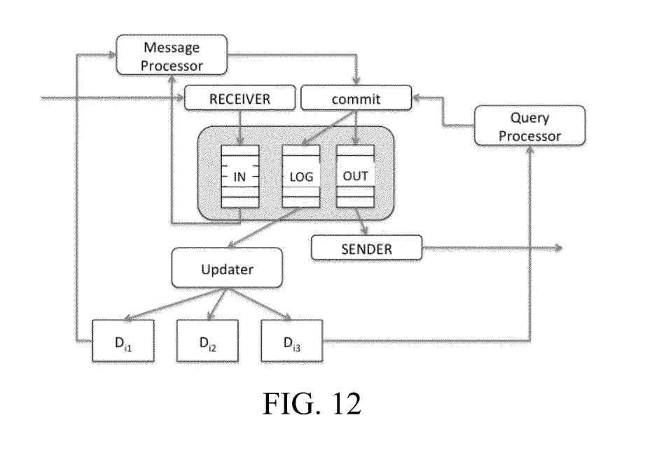

A transaction log is extended with two message buffers (outgoing and incoming) and additional APIs. A transaction can commit not only write operations but also outgoing messages. These messages may be delivered to the destination transaction log and put into the incoming buffers. A message processor handles these messages in the incoming buffer and executes a transaction on the same transaction log. This transaction will commit not only write operations but also deleting the messages from the incoming buffer. See FIG. 12.

(4) Message Buffers

Outgoing Messages

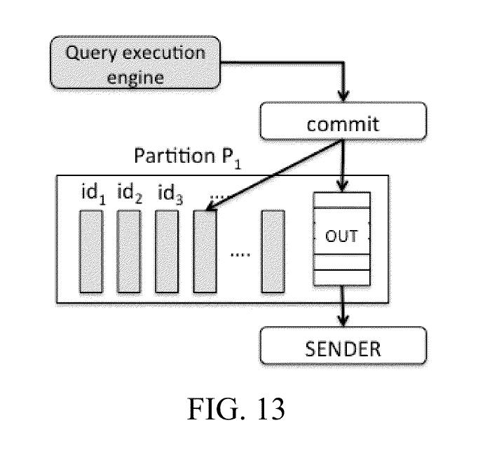

In FIG. 13 for the extended architecture, an outgoing buffer is associated with each transaction log. However, in the actual implementation we have one outgoing buffer for each partition since a transaction log and the outgoing buffer in a partition are kept consistent and migrated together.

As described later, messages are exchanged between partitions: the sender and receiver are identified with partition IDs so that delivery is guaranteed even migration happens. Thus, putting outgoing message in one buffer for each partition is a reasonable design.

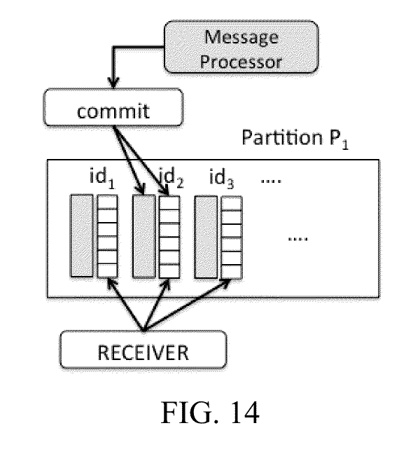

Incoming Messages

Whereas we can use one shared outgoing buffer for each partition, we can allocate individual incoming buffer for each transaction log: the message processor consumes incoming message in the buffer for each transaction log and runs transactions on it. Different transaction log shows different progress of buffer consumption. See FIG. 14.

(5) Processing Messages

Messages are processed as transactions on the destination transaction log. A message processor interprets the messages, reads data from the storage, and commits the write operations to the log. (1) A sequence of operations in a message may be processed within a single transaction; and (2) deletion of processed messages in the incoming buffer can be done as a part of the transaction in an atomic manner.

To support this, an incoming message is shown to the message processor as a Transaction object described below:

interface Transaction {

LogId getLogId( );
long getTimestamp( );
String getType( );
byte[ ][ ] getOperations( );

}

The important difference from Message is that it is associated with a timestamp that represents the order of the incoming messages. When the message processor commits a transaction, it can give this timestamp to indicate the progress and let the transaction log manager delete messages in the incoming buffer.

Retrieving Messages

Notice that a stream of incoming messages of each transaction log may be handled exclusively in order to avoid unnecessary conflict. To do that, we can use the same mechanism as the one for the data updater: mapping from partitions to message processors. The transaction log manager provides an interface for a message processor to get incoming messages (or Transaction objects) within a specific partition.

Iterable<Transaction>getTransactions(int partitionId);

Transaction Commit

The message processor may let the transaction log manager know the messages it consumed within a transaction upon a commit request. Since the message processor can process a consecutive sequence of messages in the incoming buffer, the API provides two values: start (the timestamp of the oldest message) and end (the timestamp of the newest message).

Result commit(LogId id, long start, long end,
Check check,
Write[ ] writes, Message[ ] messages);

The commit request of the message processor returns a complex value to inform two different causes of failure: (1) check fails due to conflicts, and (2) message processing is out of sync. The latter is introduced for this special commit request.

Whereas the case of 1, the message processor can redo the transaction processing with the same set of messages (identified with [start, end]), the case 2 indicates that the message processor is processing messages in an invalid order.

interface Result {

boolean isSuccessful( );
long currentTimestamp( );

}

Given the Result r with r. is Successful( ) is false, the message processor can compare the value of “start” in the commit request and the value of r.currentTimestamp( ). If they are equal, the message processing is in sync and the transaction failed due to check failure. If start is older than the current timestamp, the message processing is trying to process messages that are already processed. The message processor can feed-forward to the current timestamp. If the start is newer than the current timestamp, it means that the message processor drops messages for some reason. It may scan incoming messages again.

Message Processing Failure

Since messages are general operations with which a transaction is performed on the data, there can be failure of message processing due to invalid behavior that is specific to the operation semantics. The message processor may report it as a permanent (non-transient) failure and commit a transaction that removes the (invalid) messages from the incoming buffer. The report can be either logged or sent to somewhere appropriate. How these reports are used (e.g. how they are returned to the application level) is specific to the application.

(6) Message Exchange

In this section we discuss how to incorporate message exchange with ordered delivery guarantee into the transaction log manager, which may redistribute transaction logs among nodes in an online manner.

Transaction logs are managed a set of partitions. A partition is a unit of data assignment to cluster nodes (in our case, a partition is implemented as a TAM instance). A (master) partition can migrate from one node to another online with keeping consistency of the content of the partition.

When we consider message delivery from a transaction log to another log, we can consider partitions as senders and receivers. Log-wise messages to the same destination partition are packed into a partition-wise message, which can be delivered to a node that is responsible of the destination partition.

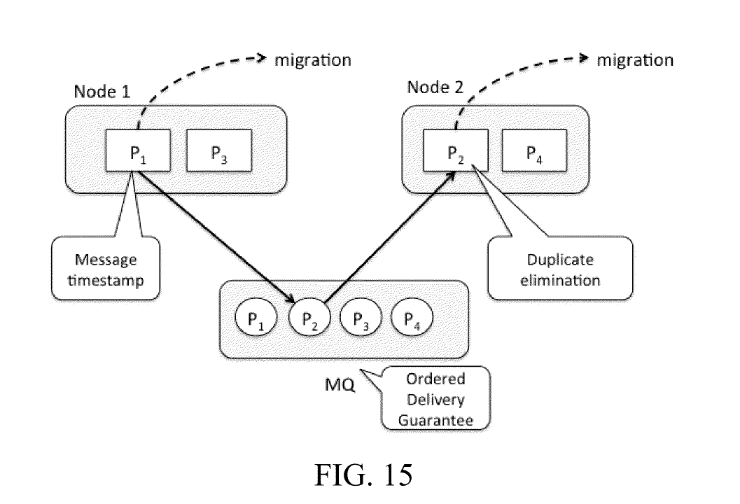

One approach is to use MQ (Message Queue). See FIG. 15.

When we use MQ, we can make sure messages are delivered to a partition exactly once in the original order. Most MQ supports ordered delivery when a single consumer accesses each queue (this is the case since there is one master partition at any time). A remaining issue is to ensure exactly once delivery. One approach is to implement XA to update a partition and a queue in a transactional manner. However, this approach might complicate implementation. Alternative approach is to enable duplicate elimination, which is discussed in the following.

Without XA, we cannot execute writing an incoming message to a partition and committing the queue (e.g. JMS commit) in an atomic manner. Thus it is possible that a message is delivered again. If incoming message is committed one by one, the receiver (e.g., the partition) can remember the last message written in the incoming message buffer. To do that, the sender may generate a globally unique message ID. We can use a pair of the sender partition ID and a locally unique ID (e.g. logical timestamp) to do that.

(7) Application: Key-Value (Hash) Index

Given the messaging mechanism, maintaining key-value indices is rather straightforward.

Consider a relation R(A, B, C) whose primary key is R.A. We now want to have an index on R.B. This index can be implemented as one key-value collection where the key represents the value of R.B and the value represents a set of value R.A. Updating the index involves updating these key-value objects. We can associate a transaction log for each key-value object in this collection.

We can introduce two operations: put(b,a) and delete(b,a). When a new record (a1, b1, c1) is inserted to R, the query execution engine can send put(b1,a1) to the transaction log that is identified by the name of the index and the value of R.b (e.g., b1). When the same record is deleted the engine can send delete(b1,a1). When the value of b is updated, it results in two messages delete(b1,a1) and put(b2,a1) sent to different destinations that are identified with b1 and b2, respectively.

We can use the following interface to implement these index operations:

interface KeyIndex extends Operation {

Command getCommand( );
byte[ ] getValue( );

}
enum Command { PUT, DELETE}

The value is the primary key (e.g., R.A in the above example) to be inserted. This operation is sent to the transaction log whose log ID represents the index name and the index key (e.g., R.B).

The message processor retrieves a key-value object that is identified with a given log ID (a pair of name and key): The name of the log is used to identify the name of a collection and the key of the log is used as the key of the object in the collection.

The key-value object retrieved represents a set of values. The message processor adds or removes the given value to create an updated set and creates a write operation on this key-value object.

(8) Application: B-Link Tree (Range) Index

Unfortunately, unlike the case of a key-value index, it is not straightforward to distribute index operations to avoid update conflicts among message processors.

FIG. 13 illustrates a B-Link tree index where each tree node is implemented as an individual key-value object. Suppose we insert value 1 at point a and value 5 at point b. If we send these operation to a and b just like the case of a key-value index, they will be applied to the same key-value object.

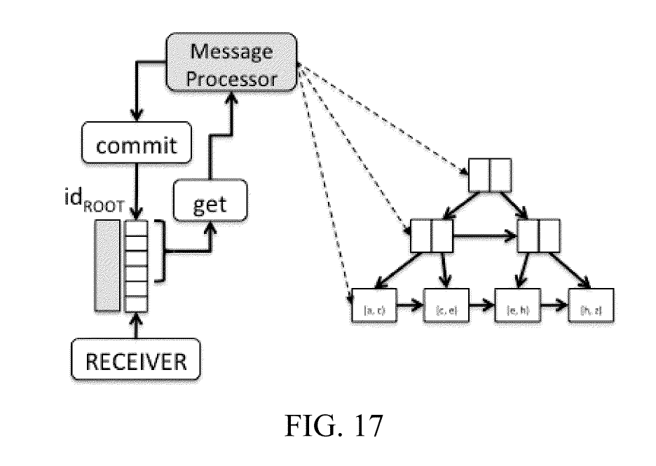

The baseline approach is to send all the operation on this index to the root node. See FIG. 17.

In the following, we discuss possible extension to improve performance.

Batch Update

Instead of processing index operations one by one, the message processor can update multiple index operations together, reducing the number of writes on key-value objects. To do that, we may want to introduce different mechanism to ensure durability and safe recovery optimized for batch update of large data.

Message Routing

Another approach is to introduce a protocol to change the ownership of ranges among the node (e.g., the corresponding massage processor). We introduce an “ownership” flag in the node data structure, indicating that this node is has the update right of its sub-tree. Initially, the root node has the ownership of everything. As nodes are split, the ownership is distributed. We can have a protocol to safely delegate the split ownership.

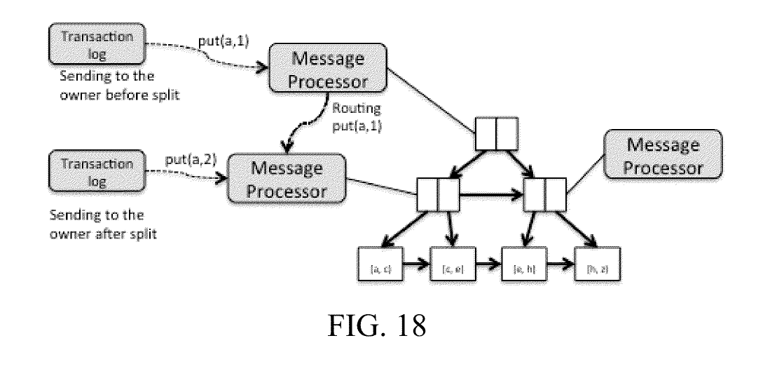

The sender of index operation first traverse B-Link tree and identifies the current owner. Splitting a node can cause a message to the node that is no longer the owner. The corresponding message processor can route this message to the new owner by using the same messaging mechanism. See FIG. 18.

7. Extension: Key-Value Write Ordering

In the architecture described above, we guarantee to generate a serializable schedule for transactions, that is, a successfully committed transaction will see a consistent snapshot of the data in an isolated manner. It is possible for a running transaction to see an inconsistent snapshot (e.g., it can observe a value after the check timestamp Tc). It is considered as a correct behavior since the transaction will never be successful.

Another concern is guarantee for non-transactional process: What can be guaranteed for a reader of the storage without interacting with the transaction log manager? The storage guarantees that the reader will never see uncommitted values since the updater will never trey to write uncommitted values. However, there is no guarantee between the values of multiple key-value objects since each key-value objects is independently updated. There are many cases when such relaxation is reasonable.

However, in the future extension of the data layout, there are cases when we want to have additional guarantee for a reader of the storage. Maintaining tree-structured data, such as B-Link tree, is a motivating example, which is described below.

To address this future issue, we introduce extension of the transaction log manager to guarantee schedule of writes on different key-value objects.

(1) Motivation: Maintaining Tree-structured Data

FIG. 13 illustrates the behavior of B-link tree when it is implemented on key-value store, by using a key-value object for each tree node. Initially, we have two leaves taking care of ranges [a, c) and [c, e) respectively. A sequence of write operations (w1, w2, w3) is to split the node [a, c) into two nodes [a, b) and [b, c).

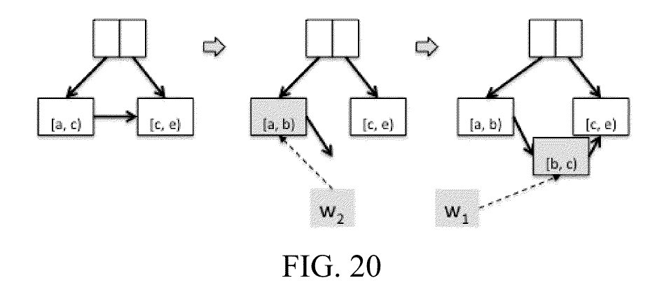

Suppose w₂ is made available before w₁ to the reader, the reader will see an inconsistent (broken) tree. This inconsistency is a transient state and the tree will eventually go back to a consistent state again. One solution is to let the reader try again to access the tree hoping to see a consistent state. However, this imposes additional cost to the readers. Typically, there will be a large number of non-isolated readers compared with the number of writers, and these readers choose the non-isolated mode for performance. Thus, it is reasonable to let the writer pay extra cost to avoid this transient inconsistency. See FIG. 20.

(2) Log Directives

To enable further control of write scheduling at the updater side, we introduce a set of log directives. A directive is inserted in the log(a sequence of write operations), and the updater can interpret this directive and behave as directed.

It is the responsibility of the query execution engine to insert directives appropriately. The transaction manager does not have to know the semantics of directives.

The interface is extended to include directives. Instead of giving an array of Write objects, now we use an array of LogOperation objects. Write and Directive are subclass (sub interface) of LogOperation.

interface LogOperation {
}
interface Write extends LogOperation {

//... same as before

}
interface Directive extends LogOperation {

byte[ ] getCommand( );

}

Sequential Write Directives

In order to avoid out-of-order writes, the updater wants to know that a particular sequence of writes on multiple key-value objects cannot be executed concurrently. We can introduce two directives, start and end, to group a sequential segment. In the above example, we can have a sequence like ( . . . , start, w1, w2, w3, end, w4, . . . ) in order to group w1, w2, and w3.

For a sequential write, the updater can ensure that the result of a write operation is made available before starting the next write operation.

Synchronize Directive

There is another type of anomaly that may cause transient inconsistency due to redoing writes after recovery.

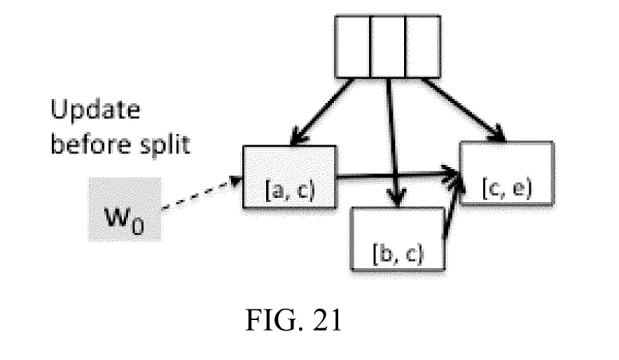

Consider a log on a B-link tree (w0, w1, w2, w3) where w0 is an insertion of data to the node [a, c) and a sequence w1-w3 is splitting the node [a, c). Suppose the updater dies after writing the log to the storage and before reporting the new SYNC time to the transaction log manager. After recovery, the updater starts writing from w0, resulting a sequence of writes (w0, w1, w2, w3, w0, w1, w2, w3). When w0 is applied to the storage for the second time, the state of the B-Link tree is like in FIG. 21.

It is arguable to say this B-Link tree is consistent. The reader can traverse the tree without failure, seeing values with different mix of timestamp depending on a query range.

In general there is a case when we don't want let the updater go back too far during the redoing. In order to control this, we can insert a synchronize directive in the log sequence. For instance, in the above example, we can insert “sync” directive right before a node split: (w0, sync, w1, w2, w3).

When the updater encounters the synchronization directive, it may not apply further write operations before it successfully synchronize the current SYNC with the transaction log.

8. Extension: Various Check Predicates

(1) Multiple Check Predicates

In the above discussion, we have one check predicate with one timestamp. We can extend to have multiple check predicates to represent multiple read sets with different timestamps.

For instance, this extension is useful in a case the query execution employs data caching.

First, we extend the commit request to return a complex value including the current timestamp (just as the result for message processor's commit request).

interface Result {

boolean isSuccessful( );
long currentTimestamp( );

}

Let the returned timestamp be Tc. When the commit is successful, it means that read sets in the check predicates are all current at the time Tc. Also, the write operations that are just committed now have timestamp Tc. The query execution engine can use this knowledge for future transaction commits. For instance, it can cache these key-value objects associated with timestamp Tc.

As a result, the query execution engine maintains key-value objects with different timestamps. Then a commit request can have multiple check predicates to include read operations on those cached values.

Result commit(LogId id, Check[ ] checks, Write[ ] writes);

(2) Extended Predicate Types

In addition, we can extend the check predicate for possible performance optimization. The following are examples of check predicates that can be efficient in some settings.

Key Signature

Instead of having a set of keys, we can consider a signature of this key set. For instance, we can use a bloom filter. By using a signature, we can represent the read set compactly at the cost of false positive on conflict detection (e.g., the check may fail even if there is no conflict). This scheme will work when update is not very frequent (e.g., log data in (SYNC, CURRENT) is not large) and a transaction reads a relatively large number of keys.

Key Ranges

Another way to represent a read set is to represent a set of key ranges. This can be a viable option when the data set managed by this transaction log is range indices.

9. Extension: Implementation for Larger Transaction Logs

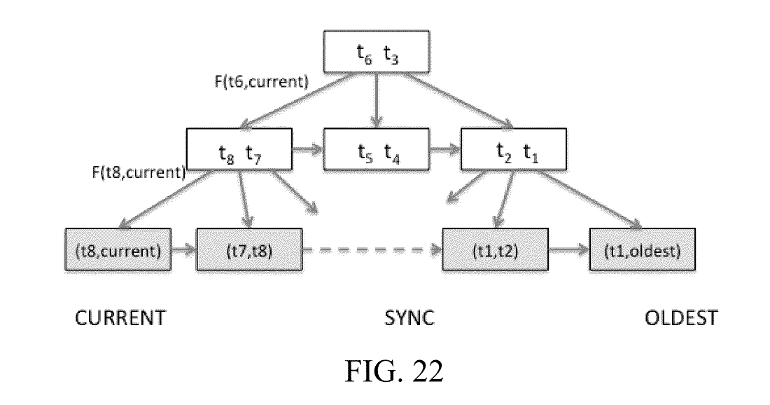

In this section we describe one approach to implement a transaction log based on bloom filters. See FIG. 22.

The data structure may be similar to B-Link Tree, but we can simplify it by exploiting the property that data is updated in a FIFO manner. When this is implemented in memory, we can set up the maximum tree size and implement each layer (siblings) of the tree as an array (ring buffer). In such a case, we do not need to implement links among siblings.

Each pointer to a child node is associated with a bloom filter that represents a set of keys in the corresponding range.

Data Insertion and Node Split

Notice that the data is always appended at CURRENT. Node split is actually adding a new empty node at the left end (head). The cost of insertion (inserting data at the leaf, adding new empty nodes when needed, updating bloom filters) is O(log_{K}N), where N is the size of log entries and K is fan-out of the tree.

Log Truncation

Deletion may be needed for truncating the log to free up the memory. For instance we can delete the oldest (rightmost) child of the root to delete 1/K of the log. The cost of this (updating the root bloom filters and the rightmost node of each layer) is O(K+log_{K}N).

Check

The worst case of exact check of given (key, time) is O(N). We expect bloom filters help the check procedure to prune a sub tree to be scanned. Also, check can be terminated anytime earlier, by using bloom filters, at the cost of false positive of conflict detection.

Achieving elasticity (for example, the ability of adding and removing server resources to adapt to workloads automatically) will reduce costs including (1) data center (cloud) operation cost, (2) data center (cloud) server cost, or (3) application development cost.

The foregoing is to be understood as being in every respect illustrative and exemplary, but not restrictive, and the scope of the invention disclosed herein is not to be determined from the Detailed Description, but rather from the claims as interpreted according to the full breadth permitted by the patent laws. It is to be understood that the embodiments shown and described herein are only illustrative of the principles of the present invention and that those skilled in the art may implement various modifications without departing from the scope and spirit of the invention. Those skilled in the art could implement various other feature combinations without departing from the scope and spirit of the invention.

What is claimed is:

1. A method implemented in an online transaction processing system, the method comprising:
upon a read request from a transaction process,
reading a transaction log,
reading data stored in a storage without accessing the transaction log, and
constituting a current snapshot using the data in the storage and the transaction log;
upon a write request from the transaction process, committing transaction by accessing the transaction log; and
propagating update in the commit to the data in the storage asynchronously,
wherein the transaction commit is made successful upon applying the commit to the transaction log.

2. The method as in claim 1, further comprising:
discarding transaction log data corresponding to the update propagated to the data in the storage,
wherein a size of the transaction log is kept substantially smaller than a size of the data in the storage.

3. The method as in claim 1,
wherein a transaction log manager manages the transaction log and uses at least one of
a data collection comprising a set of key value objects,
a timestamp comprising a value that gives a total order of commits,
a log entry comprising a sequence of one or more write operations associated with the timestamp,
a sync time, wherein the storage incorporates one or more write operations whose timestamps are equal to or older than the sync time,
a snapshot comprising a sequence of one or more write operations starting next to the sync time and ending at a particular time, and
a check predicate, wherein the check is successful in case there is no conflicting log entry.

4. The method as in claim 1,
wherein the online transaction processing system comprises a transaction log manager, a query execution engine, and a data updater,
wherein the transaction log manager manages the transaction log,
wherein the query execution engine starts reading the transaction log and commits the transaction, according to the read and write requests, respectively, and
wherein the data updater retrieves a write operation and applies the write operation to the data in the storage.

5. The method as in claim 4,
wherein the data updater informs the transaction manager that the write operation is applied, and
wherein the transaction manager truncates the transaction log upon receiving the information.

6. A system for online transaction processing, the system comprising:
a transaction log; and
data stored in a storage,
wherein, upon a read request from a transaction process,
the system reads a transaction log, reads data stored in a storage without accessing the transaction log, and constitutes a current snapshot using the data in the storage and the transaction log,
wherein, upon a write request from the transaction process,
the system commits transaction by accessing the transaction log,
wherein the system propagates update in the commit to the data in the storage asynchronously, and
wherein the transaction commit is made successful upon applying the commit to the transaction log.

7. The system as in claim 6,
wherein the system discards transaction log data corresponding to the update propagated to the data in the storage,
wherein a size of the transaction log is kept substantially smaller than a size of the data in the storage.

8. The system as in claim 6,
wherein a transaction log manager manages the transaction log and uses at least one of
a data collection comprising a set of key value objects,
a timestamp comprising a value that gives a total order of commits,
a log entry comprising a sequence of one or more write operations associated with the timestamp,
a sync time, wherein the storage incorporates one or more write operations whose timestamps are equal to or older than the sync time,
a snapshot comprising a sequence of one or more write operations starting next to the sync time and ending at a particular time, and
a check predicate, wherein the check is successful in case there is no conflicting log entry.

9. The system as in claim 6,
wherein the system comprises a transaction log manager, a query execution engine, and a data updater,
wherein the transaction log manager manages the transaction log,
wherein the query execution engine starts reading the transaction log and commits the transaction, according to the read and write requests, respectively, and
wherein the data updater retrieves a write operation and applies the write operation to the data in the storage.

10. The system as in claim 9,
wherein the data updater informs the transaction manager that the write operation is applied, and
wherein the transaction manager truncates the transaction log upon receiving the information.

11. A method implemented in a transaction log manager used in an online transaction processing system, the method comprising:
upon a read request from a transaction process, reading a transaction log;
upon a write request from the transaction process, committing transaction by accessing the transaction log; and
propagating update in the commit to the data in the storage asynchronously,
wherein the online transaction processing system
reads data stored in a storage without accessing the transaction log, and
constitutes a current snapshot using the data in the storage and the transaction log, and
wherein the transaction commit is made successful upon applying the commit to the transaction log.

12. The method as in claim 11, further comprising:
discarding transaction log data corresponding to the update propagated to the data in the storage,
wherein a size of the transaction log is substantially smaller than the data in the storage.

13. The method as in claim 11,
wherein the transaction log manager manages the transaction log by using at least one of
a data collection comprising a set of key value objects,
a timestamp comprising a value that gives a total order of commits,
a log entry comprising a sequence of one or more write operations associated with the timestamp,
a sync time, wherein the storage incorporates one or more write operations whose timestamps are equal to or older than the sync time,
a snapshot comprising a sequence of one or more write operations starting next to the sync time and ending at a particular time, and
a check predicate, wherein the check is successful in case there is no conflicting log entry.

14. The method as in claim 11,
wherein the online transaction processing system comprises a query execution engine and a data updater,
wherein the query execution engine starts reading the transaction log and commits the transaction, according to the read and write requests, respectively, and
wherein the data updater retrieves a write operation and applies the write operation to the data in the storage.

15. The method as in claim 14,
wherein the data updater informs the transaction manager that the write operation is applied, and
wherein the transaction manager truncates the transaction log upon receiving the information.
